(19) United States
(12) Patent Application Publication
(10) Pub. No.: US 2019/0300450 A1
(43) Pub. Date: Oct. 3, 2019

(54) Use of Silicon as a Stimulant for Nitrogen Absorption in a Plant

(71) Applicant: AGRO INNOVATION INTERNATIONAL, Saint-Malo (FR)

(72) Inventors: Jean-Claude YVIN, Saint-Malo (FR); Mustapha ARKOUN, Saint-Malo (FR)

(21) Appl. No.: 16/302,826

(22) PCT Filed: May 19, 2017
(86) PCT No.: PCT/FR2017/051219

§ 371 Date: Nov. 19, 2018

(30) Foreign Application Priority Data
May 19, 2016 (FR) 1654441

(51) Int. Cl. C05D 9/02; A01G 24/30

(52) U.S. Cl. CPC C05D 9/02; A01C 21/00; A01G 24/30

(57) ABSTRACT

The present invention provides the use of silicon as a stimulant for nitrogen absorption in a plant.

It also provides a method for stimulating nitrogen absorption in a plant, characterized in that it comprises supplying said plant or soils with an effective quantity of silicon.

### TECHNICAL FIELD

The invention relates to a novel use of silicon to stimulate nitrogen absorption in a plant.

### PRIOR ART

Plants need to assimilate nutrient elements in order to ensure that they grow normally. In particular, plants need to assimilate essential constituents, such as nitrogen, for the synthesis of proteins. The majority of plants obtain nitrogen from the soil and they use this element for synthesizing proteins via absorption and synthesis mechanisms more or less complex. Thus, nitrogen plays a key role in cultivation, both as regards the yield and the quality of the produce. It is therefore vital to provide plants with nitrogen in sufficient quantity and in a form that can readily be assimilated by the plant.

A lack of nitrogen in a plant causes retarded growth, small format stems and leaves, yellowing of the oldest leaves, then falling leaves. Flowering and fruiting are also affected, with small, poor quality fruit that ripens prematurely.

In order to prevent nitrogen deficiency, the plant can be supplemented with a source of nitrogen, in particular by supplying fertilizing compositions comprising a source of nitrogen. The fertilizing compositions that are generally used allows to provide the sufficient quantity of nitrogen to ensure that the plant grows normally.

There are three types of nitrogenous fertilizing: natural fertilizing of organic origin, natural or synthetic mineral fertilizing, and synthetic organic fertilizing.

The nitrogenous fertilizing that are available to farmers differ in particular in their formulation (solid, gas, or liquid). Some fertilizing are composed solely of a single form of nitrogen, such as urea (100% ureic nitrogen), anhydrous ammonia (100% NH₃), and potassium nitrate (100% nitric nitrogen). However, the majority of fertilizing have mixed compositions, i.e. they comprise several forms of nitrogen. Their composition has a substantial influence on the availability of the nitrogen to the plants. Specifically, the ammoniacal, nitric, and ureic forms are transformed at different rates determined by the microbiological activity of the soil. Urea undergoes hydrolysis in order to become the ammoniacal form. This may be adsorbed and temporarily retained on the clay-humus complex of the soil or used by the microorganisms of the soil, which are then in competition with the plant. The ammoniacal form may also change rapidly into the nitric form as soon as nitrification is active in a warm, aerated, and moist soil. The nitric form is completely free in the solution of soil and feeds the plant preferentially.

Synthetic organic nitrogenous fertilizing are the most widely used fertilizing in agriculture. Several types of synthetic organic nitrogenous fertilizing are commercially available; examples are:
ammonium sulfate that, whether crystalline or granulated, provides a fertilizer that is known as ammonium sulfate, which is frequently used in a dosage of up to 21% of nitrogen;
urea, obtained by combining ammonia and carbon dioxide formed during the synthesis of ammonia. It may be as beads or granulated, and contain up to 46% nitrogen. Urea is the most widely used source of nitrogen in the world because it has a nitrogen yield that is greater than other sources of nitrogen;
ammonium nitrate, obtained by reaction between ammonia and nitric acid. When mixed with urea, this can produce the nitrogenous solutions that are routinely used in agriculture (the standard solution dosage is 30% nitrogen). Ammonium nitrates, the most widely used nitrogenous products employed in France and in Europe, are obtained from ammonium nitrate by adding varying amounts of an inert filler (for example calcium carbonate or dolomite). They contain 21% to 33.5% of total nitrogen, including 50% of ammoniacal nitrogen and 50% of nitric nitrogen.

The nitrogenous fertilizing are often combined with sulfur-containing products. By admixing sulfur-containing products such as ammonium sulfate and/or ammonium thiosulfate, sulfur-containing nitrogenous fertilizing are obtained for which the contents of nitrogen and SO₃ are suitable for agronomic situations. As an example, for ammonium nitrates, by using a filler containing sulfur (for example calcium sulfate and/or magnesium sulfate), sulfur-containing ammonium nitrates are obtained for which the nitrogen (N) and SO₃ contents are suitable for agronomic situations.

It is also essential for the plant to be capable of correctly assimilating the nutrient elements present in their environment, in particular the nitrogen present in the fertilizing compositions or naturally present in the soil. Thus, a plant that is capable of assimilating a larger quantity of nitrogen is less sensitive to risks associated with deficiency and grows more rapidly. Thus, the quantities of nitrogen in the fertilizing compositions can be reduced, which means that (i) there is a substantial financial saving during fertilization campaigns, and (ii) losses of nitrogen by leaching can be reduced, and thus the impact of fertilization campaigns on the environment can be reduced.

There is therefore a need to develop treatments that can be used to stimulate nitrogen absorption in the plant, in particular when absorbed in the form of urea.

It is in this context that the Applicant has demonstrated—and this constitutes the basis of the present invention—that silicon can be used to stimulate nitrogen absorption in a plant, in particular when absorbed in the form of urea.

### SUMMARY OF THE INVENTION

Thus, the present invention, which is applicable in the field of agriculture, seeks to provide a novel use of silicon as a stimulant for nitrogen absorption in a plant, in particular when absorbed in the form of urea.

In accordance with a first aspect, the invention provides the use of silicon as a stimulant for nitrogen absorption in a plant.

In accordance with a second aspect, the invention provides a method for stimulating nitrogen absorption in a plant, characterized in that it comprises supplying an effective quantity of silicon to said plant or to soils.

### DETAILED DESCRIPTION OF THE INVENTION

The present invention arises from the surprising advantages demonstrated by the inventors of the stimulating effect of silicon on nitrogen absorption in a plant, in particular when absorbed in the form of urea.

Indeed, the invention provides the use of silicon as a stimulant for nitrogen absorption in a plant.

In the context of the present invention, the expression “plant” is intended to denote the plant considered as a whole, including its root system, its vegetative system, grains, seeds, and fruits.

The use of silicon allows an increased nitrogen absorption (i.e. stimulation). This stimulation of absorption allows to improve the health of the plant, thereby satisfying requirements for growth of the crop as expressed in particular in terms of improving the yield and the quality of the harvest. The use of silicon in accordance with the invention also allows to improve the efficiency of the fertilization by reducing the quantities of nitrogen used in the fertilizing compositions.

In the context of the present invention, the expression “fertilizing composition” is intended to denote any product whose use is intended to ensure or improve the physical, chemical, or biological properties of soils and the nutrition of plants. Such a composition may, for example, be a fertilizer applied via the roots or via the leaves.

It is known that fertilizers are defined as fertilizing materials whose main function is to provide plants with nutrient elements (major fertilizing elements, secondary fertilizing elements, and oligo-elements). The use of fertilizing compositions in large quantities, in particular those containing nitrogen, poses ecological problems. One of the possible responses to the undesirable effects of fertilization with nitrates (leaching problem) or with urea (evaporation problem) consists in improving the efficiency of absorption, in particular of nitrogen. This constitutes one of the principal advantages of the present invention, which arises directly from stimulating nitrogen absorption, in particular when absorbed in the form of urea.

In the context of the invention, the term “silicon” means the chemical element with the symbol Si in all of its forms. In particular, this includes silica (also known by the term “silicon oxide”), silicates (for example SiO₃²⁻ and SiO₄⁴⁻), and combined silicates. Silica exists in crystalline or amorphous forms in the free state. In its crystalline form, silica is in the form of non-molecular crystals formed by tetrahedral SiO₄ unitsbonded together via oxygen atoms in a regular manner, such as in quartz. In its amorphous form, silica is in the form of silicon dioxide (SiO₂), such as in glass. Silica is an acidic oxide that reacts with basic oxides in order to produce silicates, in particular SiO₃²⁻ and SiO₄⁴⁻. Silicates are capable of combining with other metal atoms such as, for example aluminum (Al), iron (Fe), magnesium (Mg), calcium (Ca), sodium (Na), or potassium (K). The combined silicates obtained in this manner are respectively aluminum silicate (Al₂SiO₃), iron silicate (Fe₂SiO₃), magnesium silicate (Mg₂SiO₃), calcium silicate (Ca₂SiO₃), sodium silicate (Na₂SiO₃) and potassium silicate (K₂SiO₃). In a particular embodiment, the silicon is supplied to the plant in the form of sodium silicate (Na₂SiO₃), potassium silicate (K₂SiO₃), and/or their derivatives. The derivatives may include K₂SiO₄ and Na₂SiO₄ forms, for example.

Advantageously, the silicon supplied to the plant may derive from various sources, for example from solid mineral silica (i.e. diatomaceous earth or sand), from liquid mineral silica (i.e. orthosilicic acid, Si(OH)₄), from vitreous products based on silicon (for example glass powders or fibers), and/or from organic silica.

Diatoms are marine micro-algae that secrete a silica skeleton that are found in natural quarries in the form of fossils. Diatomaceous earth is generally extracted from these natural quarries rich in fossilized diatoms. Diatomaceous earth is essentially constituted by silicon dioxide (SiO₂).

The expression “vitreous products based on silicon” is intended to denote any powdered vitreous material comprising (i) one or more mineral elements, in particular one or more mineral elements selected from potassium (K), phosphorus (P), calcium (Ca), magnesium (Mg), sulfur (S), iron (Fe), boron (B), manganese (Mn), copper (Cu) and molybdenum (Mo), and (ii) silicon. The mineral elements are preferably in the form of oxides.

Organic silica corresponds to silanol (CH₃Si(OH)₃). Organic silica may in particular originate from crop residues that are rich in silicon, for example silicon-accumulating plants such as sugar cane, rice, bamboo, sorghum, maize (corn), wheat, and grasses.

In the plant, silicon is generally transported by following the transpiration flow from the roots towards the aerial parts where it is accumulated and precipitated in order to form biogenic opals known as phytoliths. The silicon accumulation is more or less important depending on the variety of the plant. In a particular embodiment, the plant is a silicon-accumulating plant.

According to the invention, the expression “silicon-accumulating plant” is intended to denote a plant whose contains more than 1% by weight of Si relative to the weight of the dry mass of the plant (hereinafter w/w) and a Si/Ca molar ratio of >1. Silicon-accumulating plants in particular comprise bryophytes, gramineae, cyperaceae, and musaceae.

Plants that are considered to be non-accumulating are those that contain less than 0.5% of silicon (w/w of the dry mass of the plant). Plants that do not accumulate silicon comprise in particular gymnosperms and dicotyledonous plants.

In a particular embodiment, the plant is selected from rice, wheat, oats, sugar cane, barley, soya, and maize, preferably rice.

According to the invention, the expression “stimulating absorption” is intended to denote a sharp increase in absorption and/or an improvement in the absorption mechanisms. Thus, the present invention concerns the use of silicon as a stimulant for nitrogen absorption mechanisms in a plant, in particular when absorbed in the form of urea. The present invention also provides the use of silicon to increase nitrogen absorption in a plant.

In the context of the present invention, an effective quantity of silicon is supplied to the plant in order to stimulate nitrogen absorption. Thus, in a particular embodiment, the silicon is supplied to the plant in a quantity that is effective for increasing nitrogen absorption by the plant by at least 10%, at least 15%, at least 20%, at least 25%, at least 30%, advantageously at least 30%, at least 35%, at least 40%, at least 45%, advantageously at least 50%, at least 55%. In other words, the silicon supplied to the plant allows to increase the quantity of nitrogen in the plant by at least 10%, at least 15%, at least 20%, at least 25%, at least 30%, advantageously by at least 30%, at least 35%, at least 40%, at least 45%, advantageously by at least 50%, at least 55%.

The increase in absorption is measured by determining the nitrogen content in the plant. The term “increase” means with respect to the plant before supplying with silicon, for example with respect to the plant that has not been supplied with any silicon. The nitrogen “content” is expressed in w/w of dry mass, which corresponds to the mass of nitrogen contained in a sample of dried plant. The nitrogen content is measured using an appropriate analysis method.

The silicon may be supplied to the plant via the roots or via the foliage. In a particular embodiment, the silicon is supplied to the plant:
either in liquid form in root nutrient solutions, for example in a quantity of 0.5 grams per liter (g/L) to 5 g/L, and preferably of the order of 1 g/L;
or in liquid form in foliage nutrient solutions, for example in a quantity of 10 g/L to 50 g/L, and preferably of the order of 30 g/L;
or in solid form, for example in powdered or granulated fertilizers, for example in a quantity of 10 kilograms per metric tonne (kg/t) to 100 kg/t and preferably of the order of 50 kg/t.

In a particular embodiment, the silicon is supplied to the plant in a quantity of 2 kilograms per hectare (kg/ha) to 1000 kg/ha. In this embodiment, the silicon is advantageously distributed uniformly over a field or plant crop.

Silicon may also be used as a complement in fertilizing compositions such as fertilizers, as a nitrogen absorption stimulant in a plant. The silicon may be associated with other fertilizing substances conventionally used in fertilizing compositions. In a particular embodiment in accordance with the invention, an effective quantity of silicon is used in a fertilizing composition in association with one or more fertilizing substances. Fertilizing substances that are capable of being used in association with silicon may have a variety of natures and may be selected, for example, from urea, ammonium sulfate, ammonium nitrate, natural phosphate, potassium chloride, ammonium sulfate, magnesium nitrate, manganese nitrate, zinc nitrate, copper nitrate, phosphoric acid, and boric acid. Advantageously, the fertilizing substance used in association with silicon is selected from urea, ammonium sulfate, ammonium nitrate, nitrogenous solution, and/or potassium nitre.

In a particular embodiment, nitrogen is absorbed in the form of urea. Thus, the invention also provides the use of silicon as a stimulant for the absorption of urea in a plant.

The invention also aims to cover a method for stimulating nitrogen absorption in a plant, characterized in that it comprises the supplying of an effective quantity of silicon to said plant or to soils.

The silicon may be supplied to the plant via the roots or via the foliage. In a particular embodiment, the silicon is supplied to the plant:
either in liquid form in root nutrient solutions, for example in a quantity of 0.5 g/L to 5 g/L, and preferably of the order of 1 g/L;
or in liquid form in foliage nutrient solutions, for example in a quantity of 10 g/L to 50 g/L, and preferably of the order of 30 g/L;
or in solid form, for example in powdered or granulated fertilizers, for example in a quantity of 10 kg/t to 100 kg/t and preferably of the order of 50 kg/t.

In a particular embodiment, the silicon is supplied to the plant in a quantity of 2 kg/ha to 1000 kg/ha. In this implementation, the silicon is advantageously distributed uniformly over a field or plant crop.

In a particular embodiment, nitrogen is absorbed in the form of urea. Thus, the invention also provides a method for stimulating the absorption of urea in a plant, characterized in that it comprises supplying an effective quantity of silicon to said plant or to soils.

The present invention is illustrated below by the following non-limiting examples.

In these examples, and unless otherwise indicated, the percentages are expressed by weight and the temperature is ambient temperature.

### KEY TO FIGURES

FIG. 1: a graph showing the biomass of a rice plant, i.e. the dry mass of a rice plant, (i) supplied with a feed that includes silicon (Na₂SiO₃), i.e. the bar “+Si”. and (ii) supplied with a feed that does not include silicon, i.e. the bar “−Si”. The graph shows an increase of 60% for the biomass of plants supplied with feed including silicon compared with plants supplied with feed not including silicon.

FIG. 2: a graph showing the quantity of urea in a rice plant, (i) supplied with a feed that includes silicon (Na₂SiO₃), i.e. the bar “+Si”, and (ii) supplied with a feed that does not include silicon, i.e. the bar “−Si”. The graph shows an increase of 35% in the quantity of urea in plants supplied with feed including silicon compared with plants supplied with feed not including silicon. The graph shows that silicon stimulates the absorption of urea.

FIG. 3: a graph showing the quantity of silicon in a rice plant (i) supplied with a feed that includes silicon (Na₂SiO₃), i.e. the bar “+Si” and (ii) supplied with a feed that does not include silicon, i.e. the bar “−Si”. The graph shows an increase of 44% in the quantity of silicon in plants supplied with feed including silicon compared with plants supplied with feed not including silicon. The graph shows that silicon is absorbed by the plant.

### EXAMPLES

### Example 1: Preparation of Plant Material

Grains of rice, Oryza sativa L. Var ADRET, were kept at +4° C. the day before germination in order to ensure homogeneous emergence. They were then sown onto a layer of perlite in tanks containing demineralized water and were left in darkness for 10 days before being brought into the light. After 7 days, the plantlets were pricked out into 8 L tanks containing a Hoagland solution (Table 1).

TABLE 1
Composition of a Hoagland solution

| | [Final conc] mM |
|---|---|
| Macroelements | |
| CO(NH₂)₂ | 1 |
| KCl | 0.1 |
| CaCl₂ | 0.18 |
| KH₂PO₄ | 0.3 |
| MgSO₄, 7H₂O | 0.27 |
| EDTA, 2NaFe, H₂O | 0.2 |
| Microelements | |
| H₃BO₃ | 9.4 |
| MnSO₄, H₂O | 6.7 |
| CuSO₄, 5H₂O | 0.16 |
| ZnSO₄, 7H₂O | 0.15 |
| (NH₄)₆Mo₇O₂₄, 4H₂O | 0.015 |
| CoCl₂, 6H₂O | 0.1 |
| NiCl₂ | 0.04 |

Feed Including Silicon (+Si)

2 mM nitrogen was supplied to plantlets in the form of urea, [CO(NH₂)₂]. 1.5 millimoles (mM) silicon was supplied to the plantlets in the form of sodium silicate (Na₂SiO₃) which had been neutralized with HCl (1M, 30 milliliters (mL) for 8 liters (L) of nutrient solution), in order to encourage the formation of Si(OH)₄, in accordance with the reaction scheme below.

NaSiO₃+2HCl+H₂O→Si(OH)₄+NaCl₂

Nickel (40 nanomoles (nM)) was also supplied in order to promote assimilation of the urea by the plants.

The nutrient solution was changed every 2 days and the pH was adjusted to the range 5.6 to 6. The experiment was carried out in a growth chamber at +22° C. with a twelve hours on twelve hours off 12 h/12 h photoperiod under neon lights (Lumilux cool daylight, 36 watts (W)). The plants were harvested 14 days after application of the treatments.

Feed not Including Silicon (−Si)

2 mM nitrogen was supplied to plantlets in the form of urea, [CO(NH₂)₂]. Nickel (40 nM) was also supplied in order to promote assimilation of the urea by the plants.

The nutrient solution was changed every 2 days and the pH was adjusted to the range 5.6 to 6. The experiment was carried out in a growth chamber at +22° C. with a 12 h/12 h photoperiod under neon lights (Lumilux cool daylight, 36 W). The plants were harvested 14 days after application of the treatments.

### Example 2: Measurement of Physiological Parameters of the Plant

1. Determination of Foliage and Root Biomasses

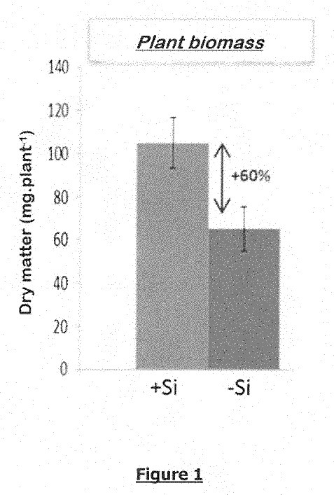

Four batches of three plants harvested in Example 1 were made up for each of the cultivation conditions (+Si and −Si) (1 batch of 3 plants=1 biological repeat). The aerial parts (leaves and stems) and root parts of each plant were separated, weighed (fresh biomass) then finely ground in liquid nitrogen. The measurement of the biomass of a whole plant is shown in FIG. 1.

Conclusion: the plants treated with silicon exhibited a significant increase in their biomass (+60%), resulting in better growth of the rice plant.

2. Biochemical Analyses

Samples of fresh ground material (obtained as described in point 1) were separated into two batches (i.e. 2 batches of ground roots and 2 batches of ground leaves) for each of the biological repeats. The first was freeze-dried for 48 h and was used to determine the dry matter and for the silicon (Si) analysis using ICP-OES (Inductively Coupled Plasma-Optical Emission Spectroscopy). The second batch was immediately immersed in liquid nitrogen then stored at −80° C. for the extraction and for the urea determination.

The series of treatments was carried out systematically for each of the biological repeats, i.e. in quadruplicate. The data obtained was presented in the form of the mean, and the variability of the results was given in the form of the standard deviation of the mean for n=4. A statistical analysis of the results was carried out using the Student's test.

Urea Determination

The urea was extracted using the method described by Arkoun et al., 2013. A Physiological and molecular study of the effects of nickel deficiency and Phenylphosphorodiamidate (PPD) application on urea metabolism in oilseed rape (Brassica napus L.). Plant and Soil, 362:79-92. Briefly, the extraction of urea and ammonium required 0.2 g of fresh material (leaves or roots) to which 1 mL of pure water was added. The tubes were immediately immersed in liquid nitrogen then placed in a water bath (80° C.) for 5 minutes (min). After centrifuging (2 min, 15000 g at 4° C.), the supernatant was recovered (supernatant 1) and the pellet was suspended in 0.5 mL of pure water, stirred (using a Vortex mixer), and centrifuged. The supernatant (supernatant 2) was recovered and added to supernatant 1 and the pellet was suspended in 0.5 mL of pure water, stirred (using a Vortex mixer), and centrifuged. The supernatant (supernatant 3) was recovered and added to supernatants 1 and 2. Finally, 2 mL of the extract (hereinafter “urea extract”) was recovered, filtered, and stored at +20° C.

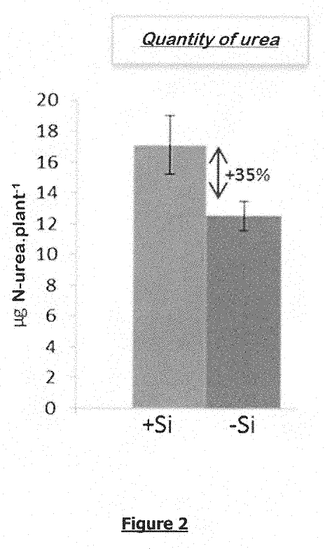

Urea determination was carried out with the aid of the method developed by Kyllingsbaek (1975), Extraction and colorimetric determination of urea in plants. Acta Agricult Scand B Soil Plant Sci 25:109-112. Briefly, 0.2 mL of urea extract was removed, and 0.6 mL of reagent was added thereto. Next, the samples were placed in a water bath at 85° C. for 30 minutes then kept at +4° C. for 20 minutes in order to stop the reaction. The measurement was carried out using a spectrophotometer at a wavelength of 545 nanometers (nm) and the urea content was determined using a calibration curve. The urea determination is shown in FIG. 2.

Conclusion: the plants treated with silicon exhibited a significant increase in the absorption of urea (+35%).

Silicon Determination

The determination of the silicon (Si) content of the samples was carried out with the aid of ICP-OES (Inductively Coupled Plasma-Optical Emission

Spectroscopy, Thermo Elemental Co. Iris Intrepid II XDL). It was preceded by digestion of the freeze-dried samples for 48 h using microwaves in an acidic medium (8 mL of concentrated nitric acid and 2 mL of hydrogen peroxide per 0.1 g of dry matter).

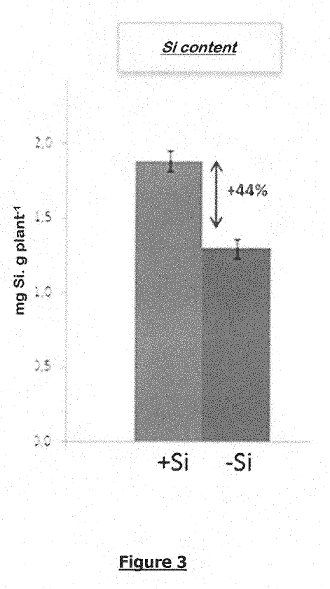

The silicon determination is shown in FIG. 3.

Conclusion: a portion of the silicon used was absorbed by the plant.

1. A method of stimulating nitrogen absorption in a plant, the method comprising supplying silicon to the plant or to soil, whereby mitrogen absorption by the plant is stimulated.

2. The method of claim 1, wherein the plant is a silicon-accumulating plant.

3. The method of claim 2, wherein the plant is selected from rice, wheat, oats, sugar cane, barley, soya and maize.

4. The method of claim 1, wherein the silicon is supplied to the plant in the form of sodium silicate (Na₂SiO₃), potassium silicate (K₂SiO₃), and/or their derivatives.

5. The method of claim 1, wherein the silicon is supplied to the plant in the form of diatomaceous earth, silicon-based soluble glass and/or organic silicon.

6. The method of claim 1, wherein the silicon is supplied to the plant in a quantity that is effective for increasing nitrogen absorption by the plant by at least 10%.

7. The method of claim 1, wherein the silicon is supplied to the plant in liquid form as a root nutrient solution, in liquid form as a foliage nutrient solution, or in solid form.

8. The method of claim 1, wherein the nitrogen is absorbed in the form of urea.

9.-14. (canceled)

15. The method of claim 3, wherein the plant is rice.

16. The method of claim 6, wherein the silicon is supplied to the plant in a quantity that is effective for increasing nitrogen absorption by the plant by at least 30%.

17. The method of claim 6, wherein the silicon is supplied to the plant in a quantity that is effective for increasing nitrogen absorption by the plant by at least 50%.

18. The method of claim 7, wherein silicon is supplied to the plant in liquid form, in a root nutrient solution, and in a quantity of 0.5 g/L to 5 g/L.

19. The method of claim 18, wherein silicon is supplied in a quantity of about 1 g/L.

20. The method of claim 7, wherein silicon is supplied to the plant in liquid form, in a foliage nutrient solution, and in a quantity of 10 g/L to 50 g/L.

21. The method of claim 20, wherein silicon is supplied in a quantity of about 30 g/L.

22. The method of claim 7, wherein silicon is supplied to the plant in solid form, in a powdered or granulated fertilizer, and in a quantity of 10 kg/t to 100 kg/t.

23. The method of claim 22, wherein silicon is supplied in a quantity of about 50 kg/t.
